(19) United States
(12) Patent Application Publication
(10) Pub. No.: US 2012/0169138 A1
(43) Pub. Date: Jul. 5, 2012

(54) NON-MOVING PART OR STATIC ELECTRIC GENERATOR

(76) Inventor: Jasbir Singh, Toowong (AU)

(21) Appl. No.: 13/395,633

(22) PCT Filed: Jan. 14, 2011
(86) PCT No.: PCT/AU2010/000031

§ 371 Date: Mar. 12, 2012

(30) Foreign Application Priority Data
Sep. 14, 2009 (AU) 2009904423

(51) Int. Cl. H01F 38/00; H02N 11/00

(52) U.S. Cl. 307/104; 74/DIG. 9

(57) ABSTRACT

A static or non-moving part electric power generator achieved by a changing (fluctuating) magnetic field (flux) by passing a pulsating direct current (DC) through a coil of wire wound on either a magnet or any material capable of producing a magnetic field, which in turn induces an alternating current (AC) in an adjacent secondary coil winding, and wherein a portion of the AC produced is used in recharging a DC source.

### FIELD OF THE INVENTION

This invention relates to electric power generation. In particular, but not exclusively, the invention relates to a non-moving parts or static electric power generator.

### BACKGROUND OF THE INVENTION

There is an energy shortage in the world as a consequence of the rapid growth in technology and industry in the light of diminishing natural resources. It is of concern that the diminishing supplies of (oil and coal) in the world have led to the search for alternative energy sources. With the advent of environmental concerns, there is the additional problem of the need for cleaner, greener and renewable forms of energy that is readily available according to need. The major energy type required for use is that of electricity which is used for transport, homes, factories, and all types of business and commercial activity.

Current solutions to address the need for renewable energy sources include solar energy via photovoltaic means or otherwise; wind energy on a large scale such as the use of wind turbines in wind farms; the use of nuclear energy to drive generators; the use of coal and petroleum generators, and hydro electric power generation of various types.

Such prior art solutions are fraught with their corresponding disadvantages. In the case of solar energy, the limitations include the need for sunlight which occurs during the day but is not available at night. Wind turbines only operate when there is wind and are expensive to install. Nuclear energy is rapidly becoming a major source of electricity but has the problem of the disposal of nuclear waste and disastrous accidents such as that which occurred at Chernobyl in Russia.

Others sources such as the use of coal and petroleum in electric power generation has been subject to the debate concerning global warming and the concern that these sources are finite and not renewable. The traditional or old method of hydro electric power generation is now considered expensive in terms of infrastructure construction and the destruction of native fauna and flora in the damming of natural heritage sites as well as in the emotional (and financial) context of the resumption of residential dwellings and land.

### OBJECT OF THE INVENTION

It is therefore an object of the present invention to provide a new and innovative source of electric power that seeks to eliminate or ameliorate some if not all of the abovementioned disadvantages of the prior art or to at least provide an alternative and useful choice.

### STATEMENT OF INVENTION

In one aspect, the invention resides in a static or non-moving parts electric power generator achieved by a changing (fluctuating) magnetic field (flux) by passing a pulsating direct current (pulsating DC) through a coil of wire wound on either a magnet or any material capable of producing a magnetic field, which in turn induces an alternating current (AC) in an adjacent secondary coil winding, wherein a portion of the alternating current (AC) is used in recharging a source of direct current (DC).

In another aspect, the invention resides in non-moving parts or static electric power generator, including in combination,
a source of direct current (DC);
an inverter to convert the direct current into a first alternating current (AC);
rectifying means to convert the first AC into a pulsating direct current (pulsating DC),
wherein in use,
second inversion means adapted to convert the pulsating DC into a second AC output,
the second AC available as a general power source, and wherein,
a portion of the second AC output can be used as a recharging current for the DC source.

Preferably, the second inversion means comprises a primary or field winding associated with a core;
a secondary winding in proximity to the field winding and core,
the secondary winding adapted to re-convert by induction, the pulsating DC passing through the field winding into the second AC output.

Preferably, the source of direct current (DC) is a battery.

Preferably, the core of the second inversion means is a material that can be magnetised and de-magnetised according to the direction of current in the primary or field winding.

Preferably, the core material is iron.

In the preferred example, the core is a material that is capable of being magnetised and demagnetised.

In the alternative, the core can be a permanent magnet.

Preferably, the primary or field winding is a copper or an aluminium wire winding.

Preferably, the secondary winding is a copper or an aluminium wire winding.

Preferably, the secondary winding is also associated with the core wherein the pulsating DC passing through the field winding creates a moving magnetic field that initiates a voltage and current in the secondary winding.

In a preferred example, the field and secondary windings are assembled with a common core.

In an alternative example, the field and secondary windings are associated with separate cores or a combination of both cores.

Preferably, the rectifying means comprises a diode and a variable resistor, the diode connected to the inverter, wherein only the half phase of the first AC is rectified as pulsating DC; the diode further connected to the field coil(s) together with the variable resistor adapted to control current flow in the field coil(s) which in turn controls the AC output of the secondary coil(s).

Suitability, the remaining half phase of the first AC can also be rectified by an identical arrangement to similarly produce another AC output which has a 180 degree phase difference.

Preferably, the secondary windings are wound around the core both in a clockwise and a counter clockwise direction to minimise back electromotive force (EMF), which are also known as coil and compensation windings, respectively or vice versa.

Preferably, there are no output voltage regulation means required, however, should there be a need to regulate the voltage under load conditions, in the absence of electronic voltage regulators, a carbon pile voltage regulator or any other voltage regulating device.

Preferably, the source DC is a 12/24 Volt DC power supply; however other DC sources may be used.

Preferably, the inverter to convert the direct current is a 115/240 Volt, 50/60 hertz, current inverter. However, other voltage/current combinations may be possible.

Preferably, the second alternating current is also 115/240 Volts at 50/60 hertz.

Preferably, the source of direct current (DC) is a battery connected to one or more capacitors which is in turn connected to the inverter.

Preferably, the source of direct current (DC) is a plurality of batteries connected in parallel.

In an alternative example, the inverter can be replaced by a pulse width modulator.

Preferably, the second inversion means comprises clockwise and counter clockwise wire windings wherein the windings comprise the second AC output.

Suitably, aluminium foil can be used between successive windings to reduce the effect of Eddy current and laminated bars are used as cores for windings to reduce heat produced as a consequence of electromagnetic hysteresis.

Preferably, there is inclusion of a voltage regulator to regulate the power output.

In an alternative example, the pulsating direct current (pulsating DC) can be passed through a field winding which is split into two or more separate windings.

In a further example, a 90 degree or other phase shifter can be used to produce a four (4) or more phase generator.

Suitably, the source of power supply can be replaced by a source of AC power which is then connected to a 90 degree or other phase shifter to produce a four (4) or more phase generator.

In an alternative example, a bridge rectifier can be used to double the frequency of the second AC output relative to the first AC.

### BRIEF DESCRIPTION DRAWINGS

In order for the invention to be better understood and put into practical effect, reference will now be made to the accompanying drawings, wherein;

FIGS. 1A, 1B and 1C show an arrangement of field and secondary coils of the invention;

FIGS. 2A and 2B show a further arrangement of field and secondary coils;

FIGS. 3A and 3B show another version of the field and secondary coils respectively, and FIG. 3C shows the relationship of the coils of FIG. 3A and FIG. 3B;

FIG. 4A shows the complete assembly of the power generator;

FIG. 4B shows the assembly of FIG. 4A used to power further static generators;

FIG. 4C shows a variation of a complete assembly whereby instead of diodes connected to the field windings a bridge rectifier is used;

FIG. 5 shows samples of a core according to the invention;

FIGS. 6A, 6B and 6C show a variation of the power supply circuit;

FIG. 7 shows a preferred secondary winding;

FIG. 8 shows a complete power supply circuit with a voltage generator;

FIG. 9 shows a variation of the field windings, and

FIGS. 10A and 10B show examples of a four (4) phase static generator.

### DETAILED DESCRIPTION OF THE DRAWINGS

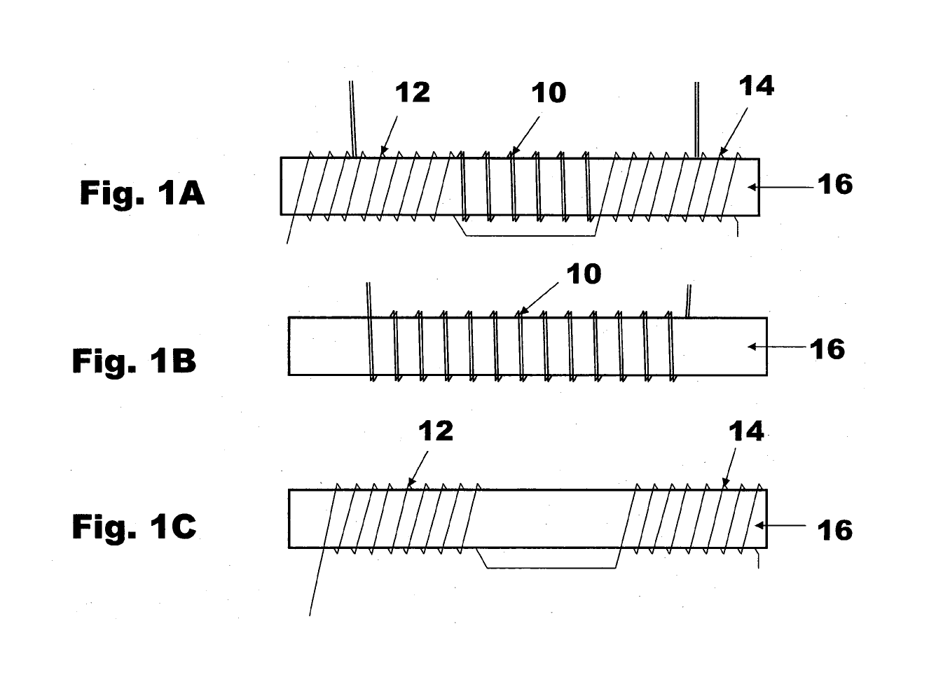

Referring now to FIGS. 1A to 1C there is shown a preferred but not necessarily the only arrangement of the field 10 and secondary windings 12, 14 of the invention wherein there is shown a core 16, preferably a soft iron, wherein the secondary winding is wound around the core along the length of the core. The primary winding or field coil is wound in the middle of the secondary winding and simply, probably on top of the secondary winding, separated by an insulator (not shown) or even a magnetic material.

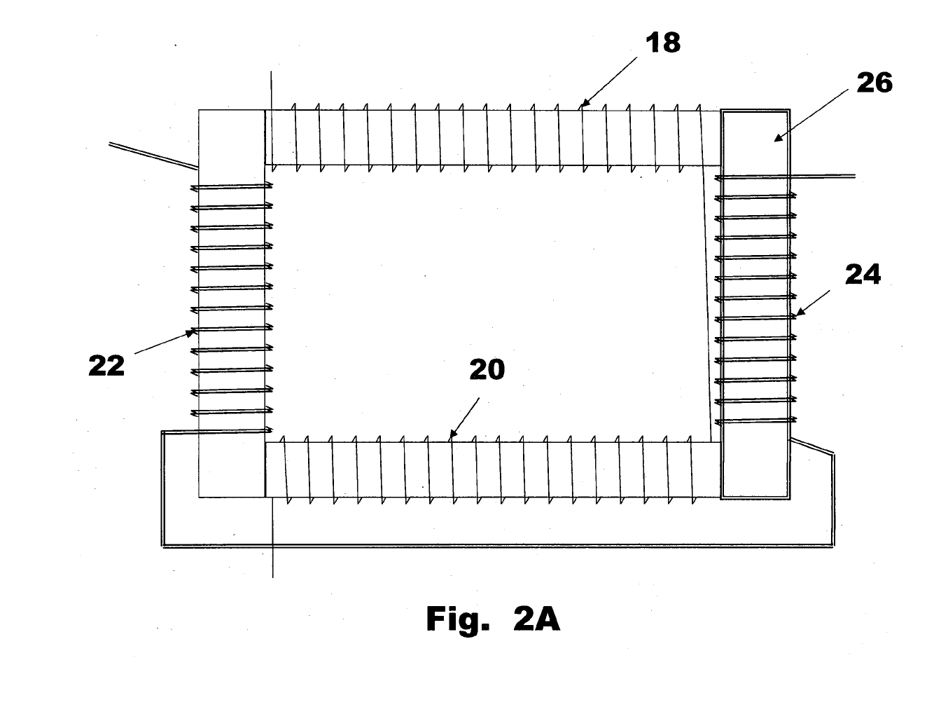

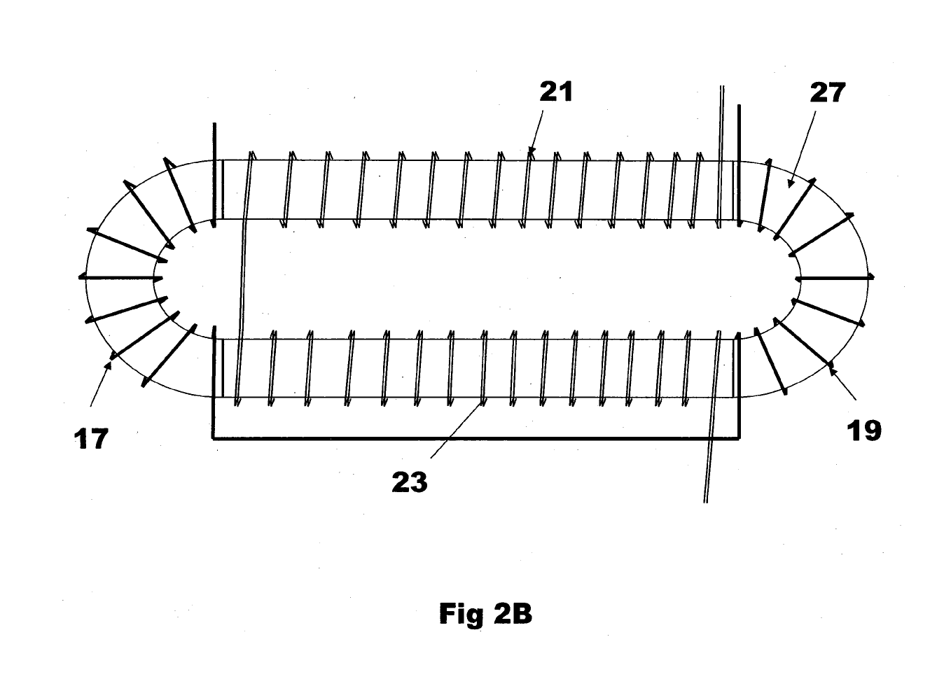

FIGS. 2A and 2B show another arrangement of primary field 18, 20 and secondary windings 22, 24 around a rectangular core 26 and field windings 17, 19 and secondary windings 21, 23 around a C-shaped and straight core 27. In this case, the field coils are shown in the horizontal position and are wound around the horizontal sections of the core, whereas the secondary windings are shown wound around the vertical portions and curved sections of the respective cores.

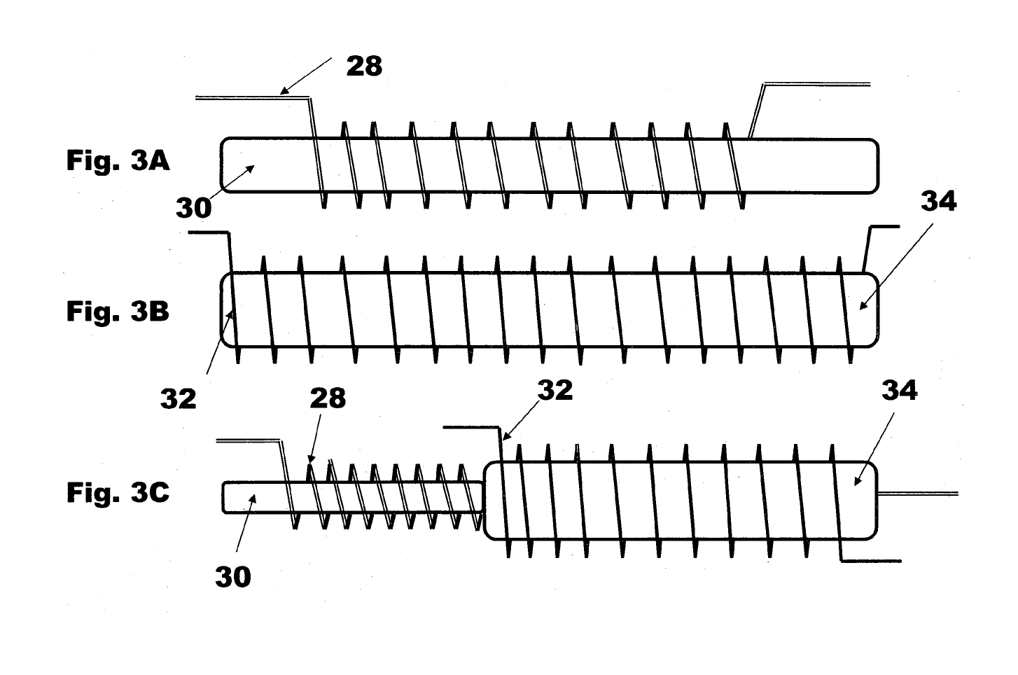

FIG. 3A shows a primary winding 28 around a soft iron bar as a core 30. The primary windings end before the ends of the core in order to allow for some cooling capacity of the core.

FIG. 3B shows the secondary windings 32 or coil wound around a plastic insulator 34 or magnetic material of an internal diameter able to slide over the primary windings 28 and the core 30 of FIG. 3A.

FIG. 3C shows the primary or field winding 28 and core 30 of FIG. 3A being inserted into the insulator or magnetic material 34 and secondary coil 32 of FIG. 3B thereby creating a moving magnetic field when the primary winding is energised which is induced into the secondary winding.

The non-moving parts or static electric generation means is a description of the arrangement between the primary and secondary windings wherein there are no moving parts.

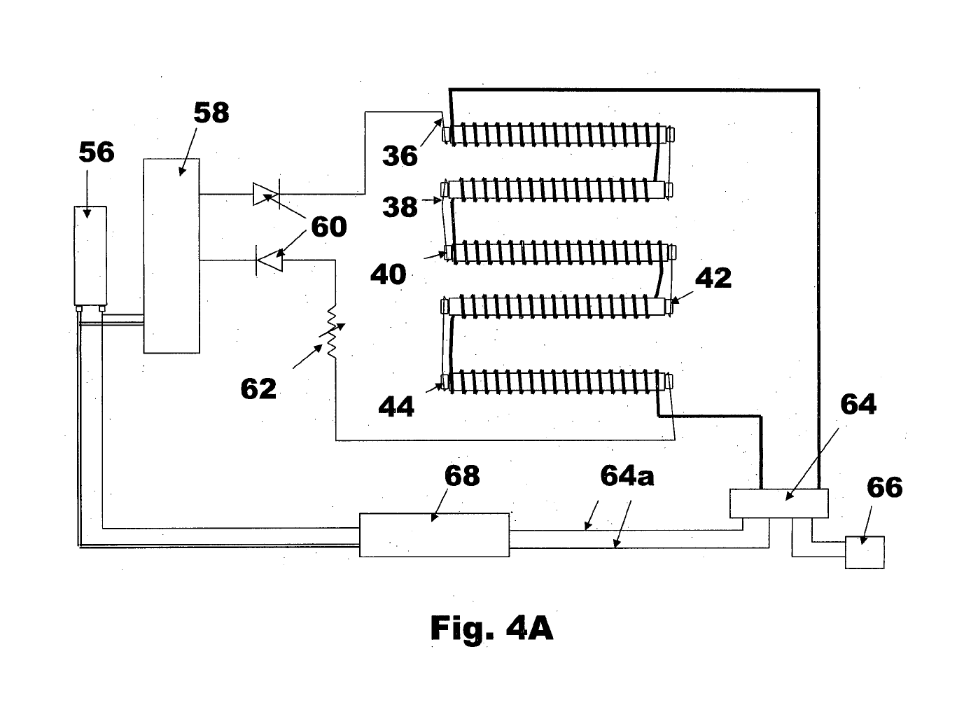

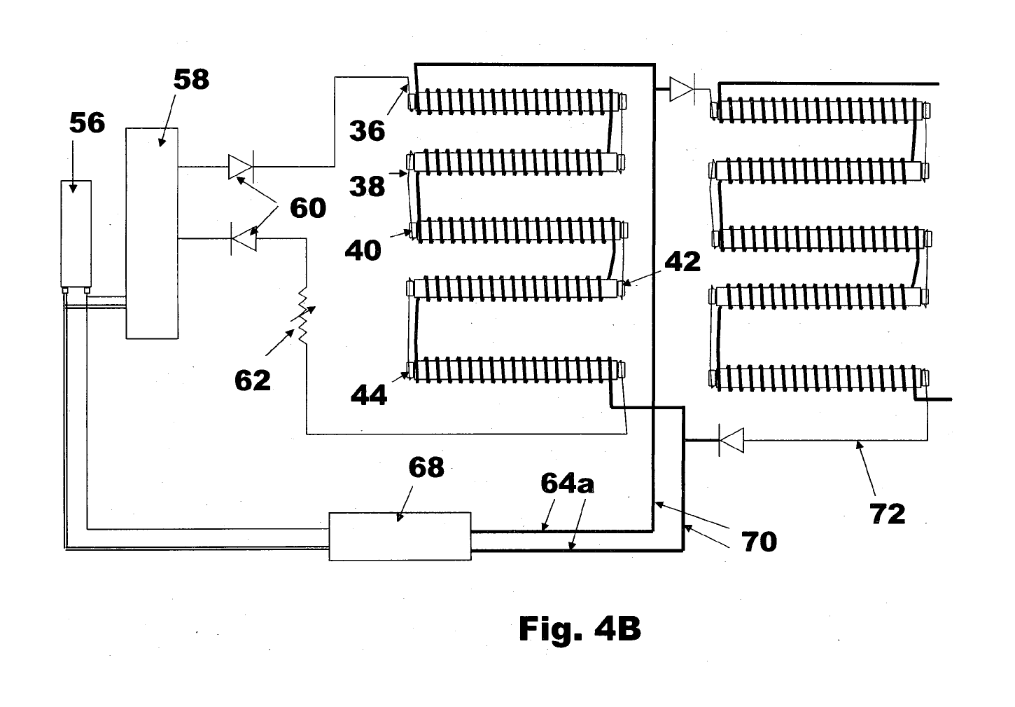

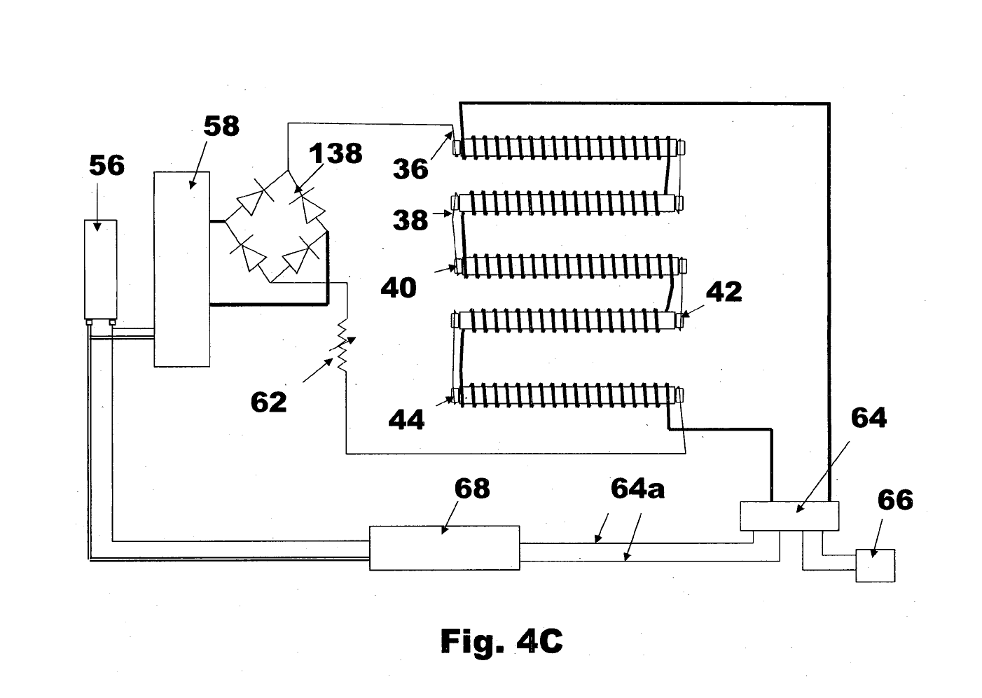

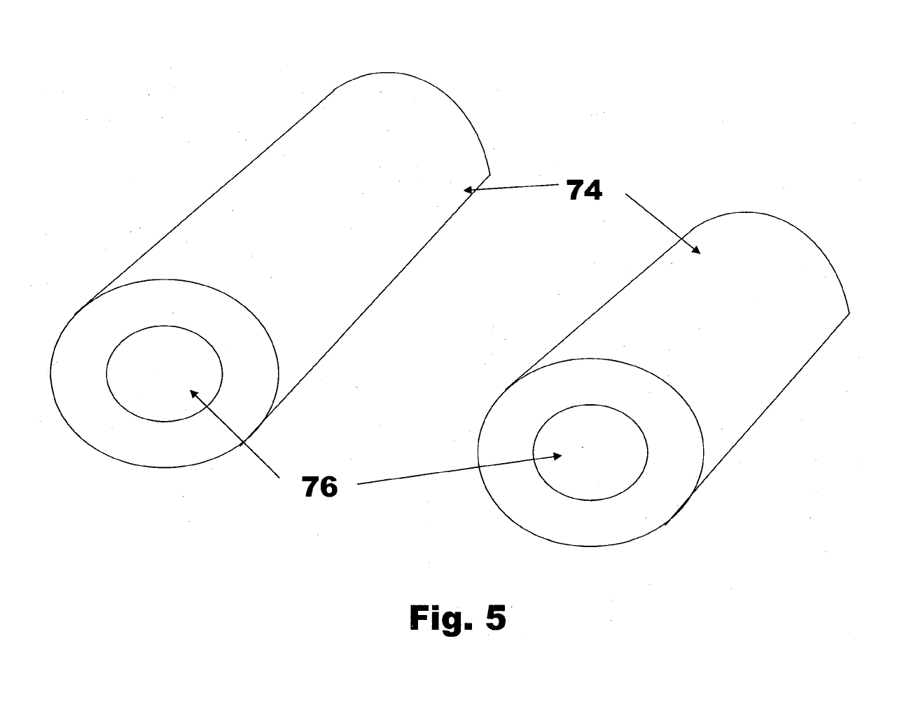

FIG. 4A shows the complete assembly of the static or non-moving parts power generator of the invention. While the embodiment shown has five (5) primary and secondary windings, one primary and secondary winding may be used for the power generation. This means that the invention is not limited to the use of one primary or secondary winding and more may be used with the relevant number of cores.

There is shown primary windings 36, 38, 40, 42, 44 around cores as well as secondary windings 46, 48, 50, 52, 54 around cores. The power source 56 which is a 12 Volt DC battery is connected to an inverter 58 which converts the 12 Volt DC voltage of the battery into a pulsating DC current via a diode 60 and variable resistor 62 connected to the inverter and to the primary or field windings.

The variable resistor is used to control the alternating current output 64 from the secondary windings which is then used to connect to or power other alternating current devices 66. As shown, a portion of the alternating current output 64a can be used to recharge the battery by means of a battery charger 68 circuit or a proprietary battery charger.

As it will be apparent that only the half wave of the alternating current produced by the inverter is used in generating the pulsating DC, the other half wave can also be used to produce a similar amount of alternating current output by an identical circuit.

FIG. 4B shows an alternative example, wherein the AC produced 70 can be used to power further like static generator arrangements 72, without additional battery power sources or inverters.

FIG. 4C shows another example of a complete assembly whereby instead of diodes connected to the field windings a bridge rectifier (138) is used. In this circuitry the output from this static generator is that the output AC (64) frequency is doubled that of the input AC to the field windings.

FIG. 5 shows one example of a core assembly 74 according to the invention wherein the core is a soft iron cylindrical rod with a hole 76 passing the length of the rod for cooling purposes. A coolant, such as water, oil, or air, can be fed through the hole.

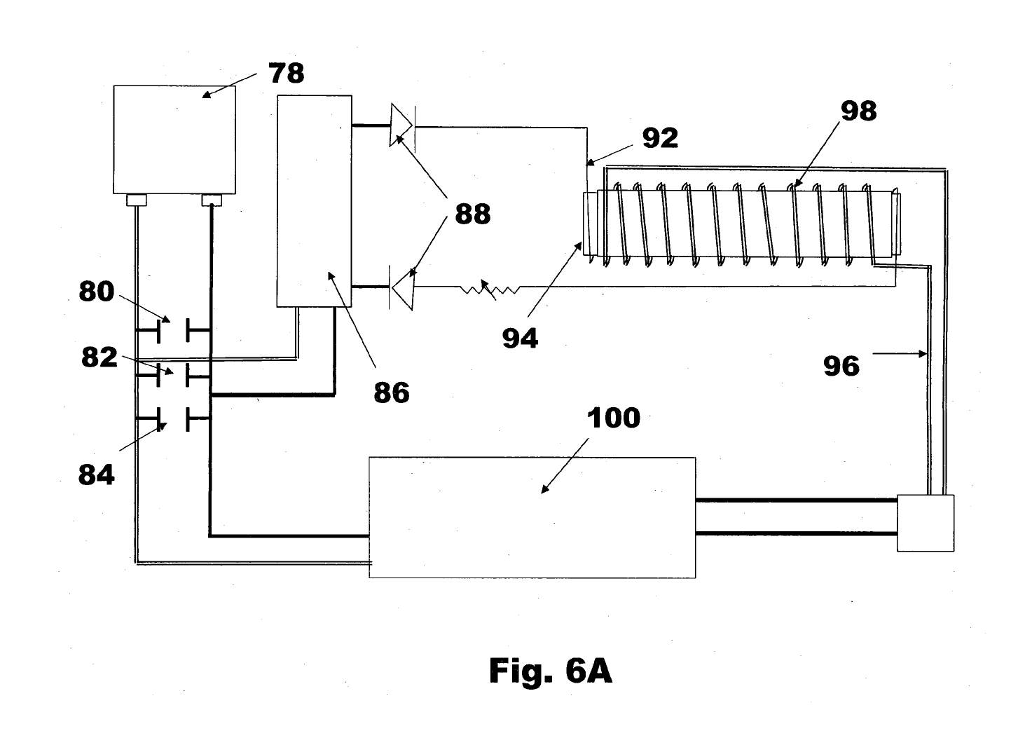

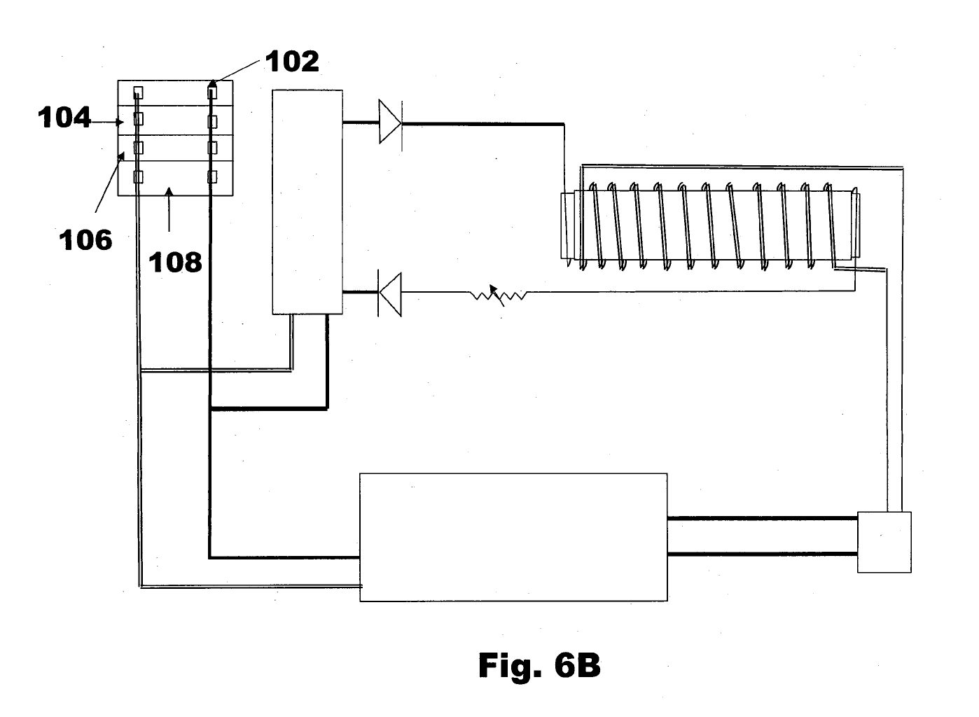

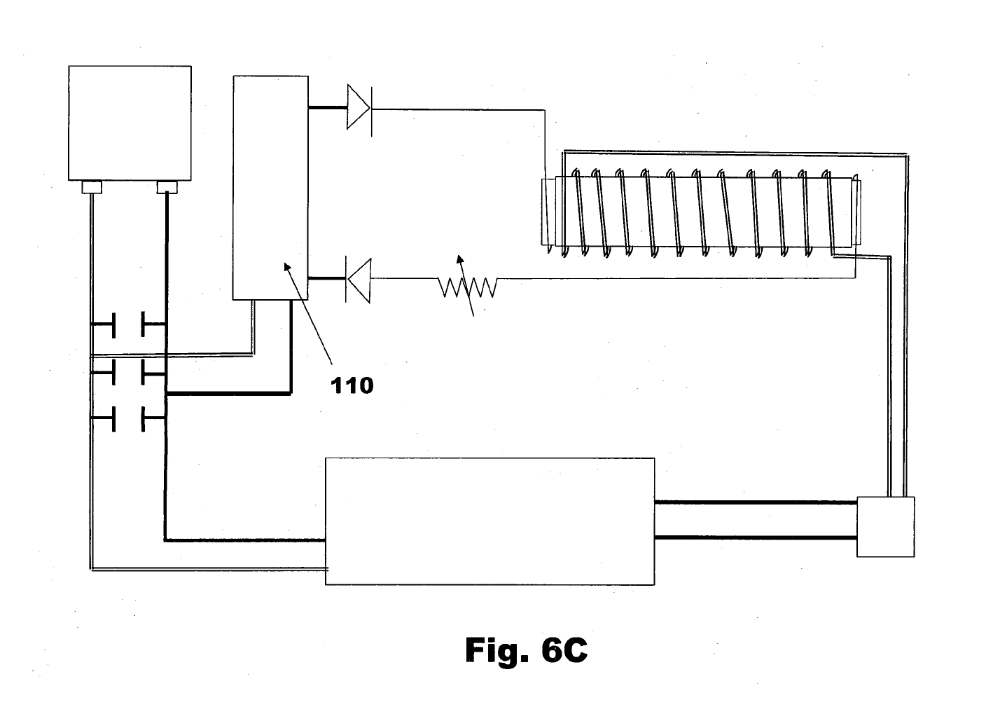

FIG. 6A shows one variation of the power supply circuit comprising a battery 78 connected to a number of capacitors 80, 82, 84 which in turn is connected to an inverter 86. The power from the inverter is connected via a diode 88 to the input field winding 92 wound on an iron bar 94. The output 96 from the secondary winding 98 is then taken to be connected to a battery charger or rectifier 100 which is connected to the capacitors 80, 82, 84.

FIG. 6B shows another variation of the power supply circuit wherein the capacitors are replaced by a number of batteries 102, 104, 106, 108 connected in parallel.

FIG. 6C shows yet another variation of the power supply circuit wherein a pulse width modulator 110 is used instead of an inverter.

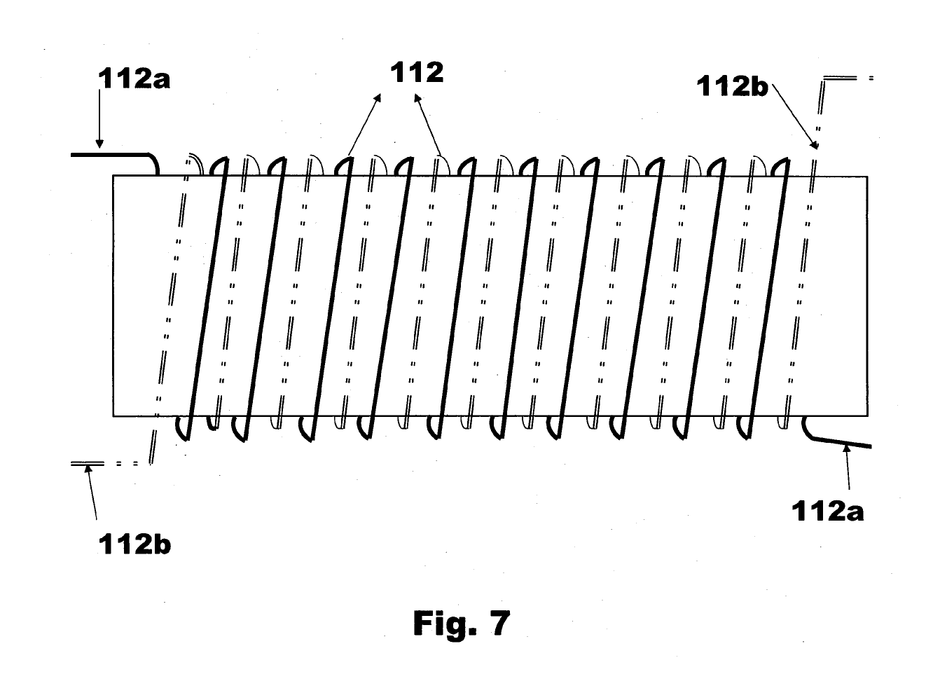

FIG. 7 shows an example of a preferred secondary winding 112 which comprises clockwise 112a and counter clockwise 112b wire windings. The combined power from these windings is taken as the power output of, the generator (not shown). To reduce the effects of Eddy current in the coils, aluminium foil can be used between each successive winding. Preferably, laminated bars are used as cores for the windings to reduce the heat build up as a result of electromagnetic current hysteresis.

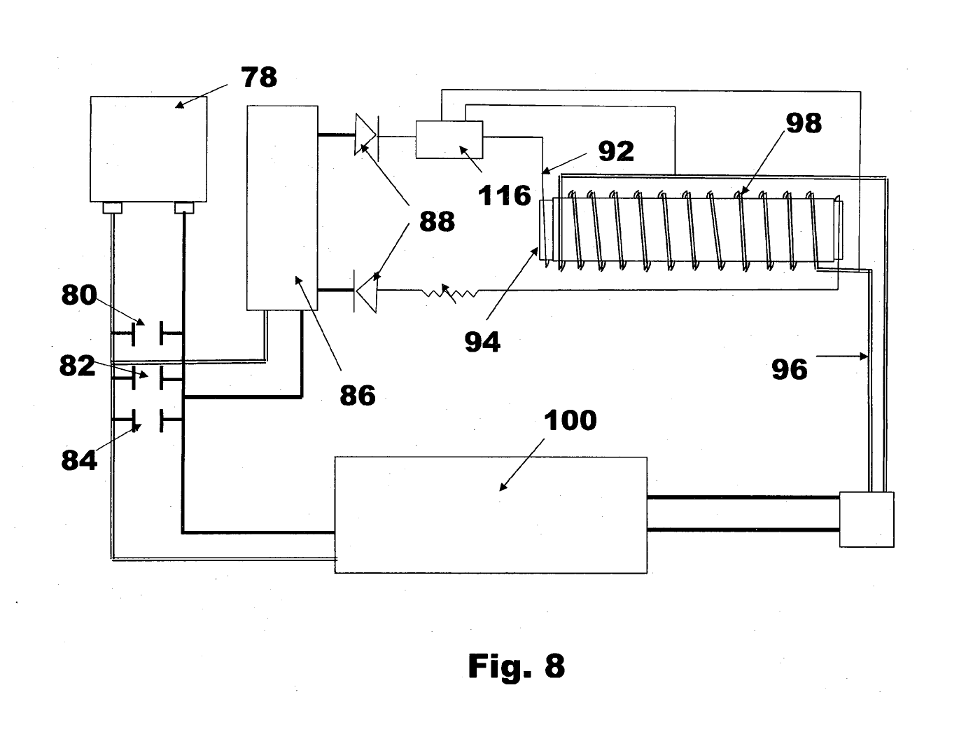

FIG. 8 shows a complete power supply circuit with a voltage regulator 116. The voltage regulator can be a carbon pile voltage regulator. In this type of voltage regulation, output from the secondary output windings is fed back to the carbon pile thereby reducing the resistance of the circuit or vice versa, increasing the resistance thereby reducing the current flow to the input field (primary windings) to regulate the output voltage of the secondary windings.

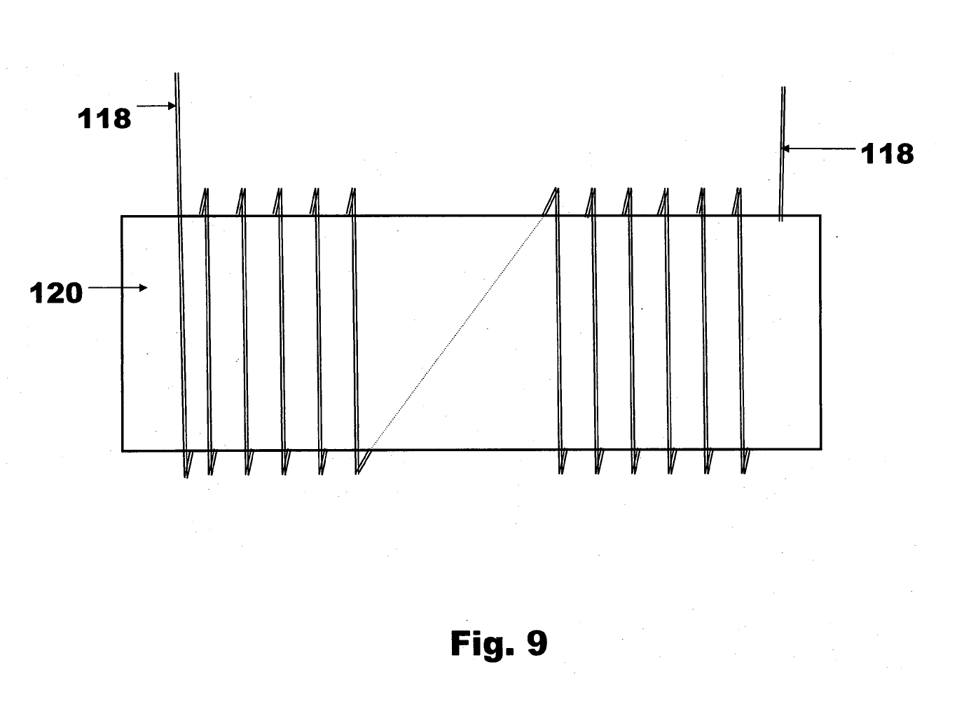

FIG. 9 shows a variation of the primary of field windings 118 of the core 120. The windings 118 are wound the same as the other cores except that in this case the primary windings are wound with a separation or space between the windings 118. The windings may be wound all around the core or split into two or more separate windings.

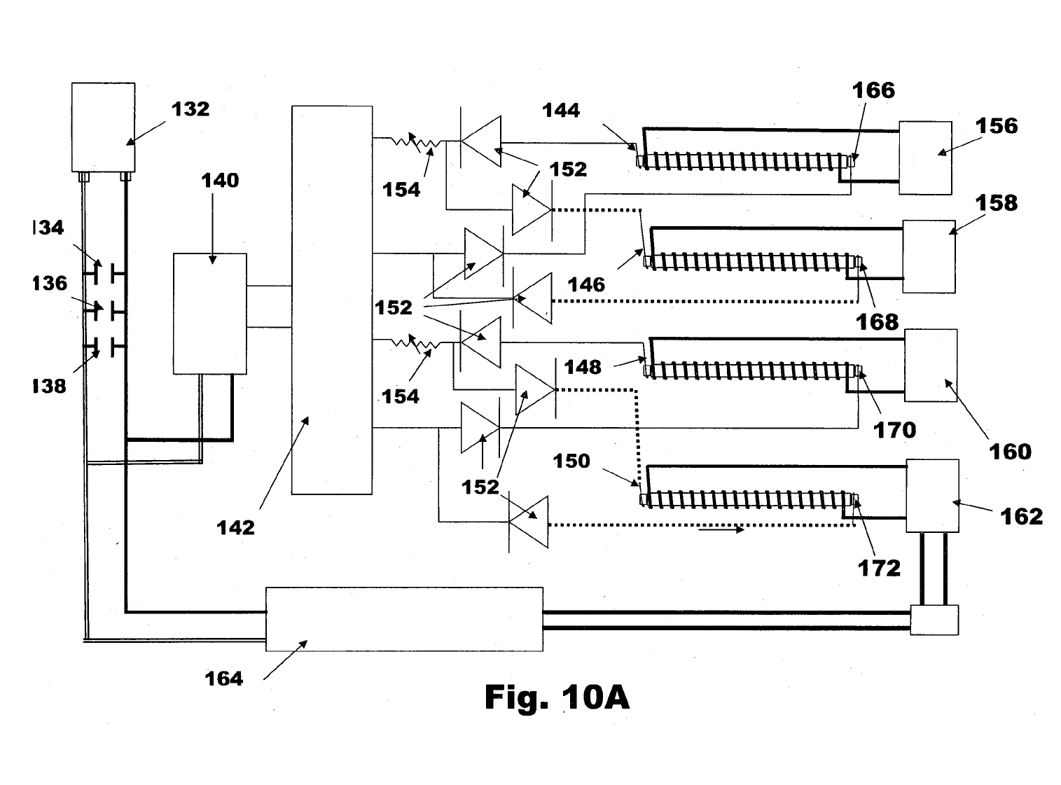

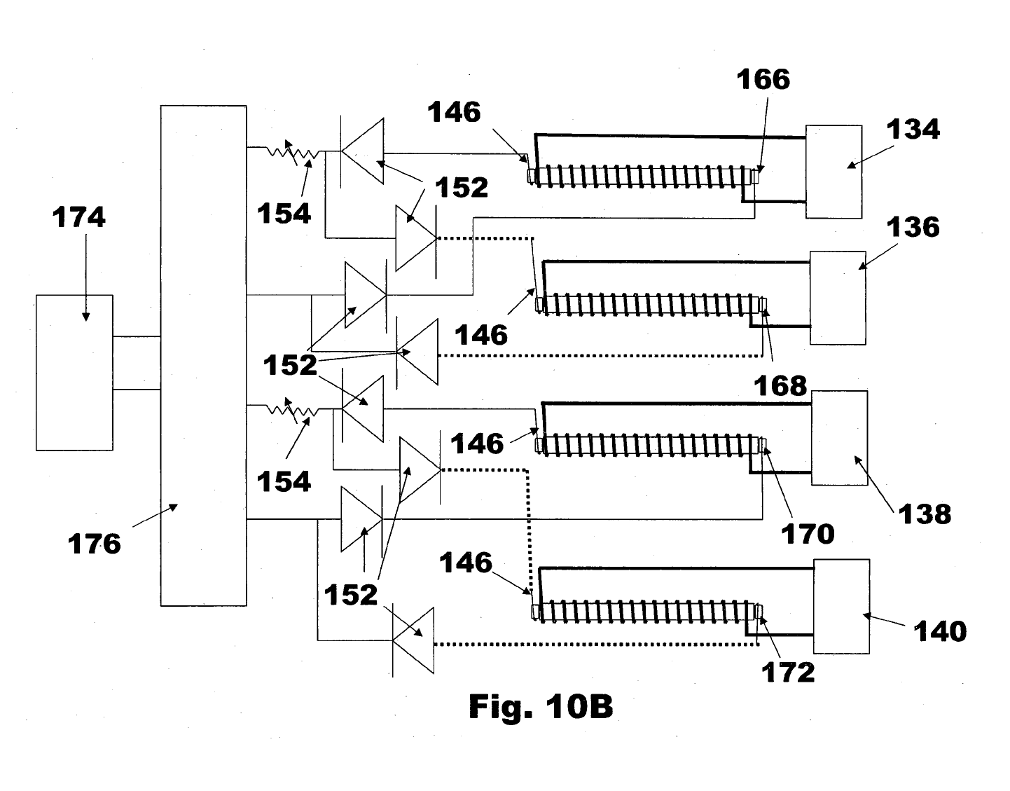

FIG. 10A shows a standalone four phase static generator, wherein the battery power source (132) is connected to a number of capacitors (134, 136 and 138) which are connected to an inverter (140) and to a 90 degree phase shifter (142). The output from this phase shifter has an original input phase and a 90 degree phase difference is then fed to four input field windings or primary coil windings (144, 146, 148 and 150) of the cores (166, 168, 170 and 172) via the diodes (152) and the variable resistor (154). This gives an AC output from the secondary coils (156, 158, 160 and 162) which are 90 degrees out of phase from each other. This also results a four (4) phase static generator. The output from one of the phases is then fed to a rectifier or a battery charger (164) to power the circuit or it could be charged by other like static generator circuits.

FIG. 10B shows an AC single phase power source (132), which is connected to a 90 degree phase shifter (142). The output from the phase shifter has a original phase and the 90 degree phase difference is then fed to four (4) input field windings or primary coils (144, 146, 148 and 150) of cores (166, 168, 170, and 172) via diodes (152) and variable resistor (154). This then gives an AC output on the secondary coils (156, 158, 160 and 162) which are 90 degrees out of phase with each other. This results in a four (4) phase generator.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

1. A static or non-moving parts electric power generator, comprising:
a coil of wire wound on either a magnet or any material capable of producing a magnetic field, the coil of wire configured to pass a pulsating direct current (pulsating DC), which is configured to create a changing (fluctuating) magnetic field (flux), and configured to induce an alternating current (AC) in an adjacent secondary coil winding, wherein a portion of the alternating current (AC) is configured for use in recharging a source of direct current (DC).

2-29. (canceled)

30. A non-moving parts or static electric power generator, comprising:
a source of direct current (DC);
an inverter configured to convert the direct current into a first alternating current (AC);
rectifying means configured to convert the first AC into a pulsating direct current (pulsating DC); and
a second inversion means comprising a primary or field winding associated with a core, and a secondary winding in proximity to the field winding and core, the secondary winding adapted to re-convert by induction, the pulsating DC passing through the field winding into the second AC output, and wherein a portion of the second AC output is used as a recharging current for the DC source.

31. The non-moving parts or static electric power generator of claim 30, wherein the source of direct current (DC) is a battery.

32. The non-moving parts or static electric power generator of claim 30, wherein the core of the second inversion means is a material that can be magnetized and de-magnetized according to the direction of current in the primary or field winding.

33. The non-moving parts or static electric power generator of claim 30, wherein the core is a material that is capable of being magnetized and demagnetized.

34. The non-moving parts or static electric power generator of claim 30, wherein the core material is iron.

35. The non-moving parts or static electric power generator of claim 30, wherein the core is a permanent magnet.

36. The non-moving parts or static electric power generator of claim 30, wherein the primary or field winding is a copper or an aluminum wire winding.

37. The non-moving parts or static electric power generator of claim 30, wherein the secondary winding is a copper or an aluminum wire winding.

38. The non-moving parts or static electric power generator of claim 30, wherein the secondary winding is associated with the core wherein the pulsating DC passing through the field winding creates a moving magnetic field that initiates a voltage and current in the secondary winding.

39. The non-moving parts or static electric power generator of claim 30, wherein the field and secondary windings are assembled with a common core.

40. The non-moving parts or static electric power generator of claim 30, wherein the field and secondary windings are associated with separate cores or a combination of both cores.

41. The non-moving parts or static electric power generator of claim 30, wherein the rectifying means comprises a diode and a variable resistor, wherein the diode is connected to the inverter, wherein only the half phase of the first AC is rectified as pulsating DC, and wherein the diode is further connected to the field coil(s) together with the variable resistor adapted to control current flow in the field coil(s) which in turn controls the AC output of the secondary coil(s).

42. The non-moving parts or static electric power generator of claim 30, wherein the remaining half phase of the first AC can also be rectified by an identical arrangement to similarly produce another AC output which has a 180 degree phase difference.

43. The non-moving parts or static electric power generator of claim 30, wherein the secondary windings are wound around the core both in a clockwise and a counter clockwise direction to minimize back electromotive force (EMF), as coil and compensation windings, respectively or vice versa.

44. The non-moving parts or static electric power generator of claim 30 further configured to output voltage regulation means comprising a carbon pile voltage regulator or any other voltage regulating device.

45. The non-moving parts or static electric power generator of claim 30, wherein the source DC is a 12/24 Volt DC power supply.

46. The non-moving parts or static electric power generator of claim 30, wherein the inverter configured to convert the direct current is a 115/240 Volt, 50160 hertz is a current inverter.

47. The non-moving parts or static electric power generator of claim 30, wherein the second alternating current is 115/240 Volts at 50160 hertz.

48. The non-moving parts or static electric power generator of claim 30, wherein the source of direct current (DC) comprises a battery connected to one or more capacitors which is in turn connected to the inverter.

49. The non-moving parts or static electric power generator of claim 30, wherein the source of direct current (DC) comprises a plurality of batteries connected in parallel.

50. The non-moving parts or static electric power generator of claim 30, wherein the inverter comprises a pulse width modulator.

51. The non-moving parts or static electric power generator of claim 30, wherein the second inversion means comprises clockwise and counter clockwise wire windings, and wherein the windings comprise the second AC output.

52. The non-moving parts or static electric power generator of claim 30 further comprising aluminum foil between successive windings configured to reduce the effect of Eddy current and laminated bars as cores configured for windings to reduce heat produced as a consequence of electromagnetic hysteresis.

53. The non-moving parts or static electric power generator of claim 30 further comprising a voltage regulator to regulate the power output.

54. The non-moving parts or static electric power generator of claim 30, wherein the pulsating direct current (pulsating DC) is passed through a field winding which is split into two or more separate windings.

55. The non-moving parts or static electric power generator of claim 30 further comprising a 90 degree or other phase shifter to produce a four (4) or more phase generator.

56. The non-moving parts or static electric power generator of claim 30, where the source of power supply is replaced by a source of AC power which is then connected to a 90 degree or other phase shifter and configured to produce a four (4) or more phase generator.

57. The non-moving parts or static electric power generator of claim 30 further comprising a bridge rectifier configured to double the frequency of the second AC output relative to the first AC.
